(19) United States
(12) Patent Application Publication
(10) Pub. No.: US 2025/0335999 A1
(43) Pub. Date: Oct. 30, 2025

(54) IMPROVED INTERFACE FOR INSURANCE CLAIMS

(71) Applicants: Surendran NARAYANAMOORTHY, Aurora, IL (US); Francisco Munoz Soler, Chicago, IL (US); Gregory D ALLING, Essex Junction, VT (US); Kristy M KOURKOUMELIS, Bolingbrook, IL (US); Varun SRIDHARAN, CHICAGO, IL (US)

(72) Inventors: Surendran NARAYANAMOORTHY, Aurora, IL (US); Francisco Munoz Soler, Chicago, IL (US); Gregory D ALLING, Essex Junction, VT (US); Kristy M KOURKOUMELIS, Bolingbrook, IL (US); Varun SRIDHARAN, CHICAGO, IL (US)

(73) Assignee: CCC INTELLIGENT SOLUTIONS, INC., CHICAGO, IL (US)

(21) Appl. No.: 18/644,819

(22) Filed: Apr. 24, 2024

(51) Int. Cl. G06Q 40/08; G06F 9/451

(52) U.S. Cl. CPC G06Q 40/08; G06F 9/451

(57) ABSTRACT

The system and method may determine a claim type and may determine needed claim information for the claim type. The system and method may review material submitted for needed claim information and determine missing information from needed claim information. The missing information may be obtained from an additional source, the needed claim information may be completed, and the needed claim information may be displayed in a user interface or dashboard which may contain all the data needed to determine a claim.

### BACKGROUND

In the past, evaluating insurance claims required a significant amount of time from humans to search paper files and find relevant information to completely evaluate the claim. As an example, a claim for an injury may require reviewing medical records and letters from attorneys to determine the extent of injuries. Analyzing letters from attorneys is a very different task than analyzing medical records and trying to find relevant data in the records has long been a challenge. Oftentimes, important information is missing and human have to sift files and outside sources to find the important missing information. Further, gathering the data in a single user interface that can be easily reviewed as needed has been inconsistent, at best.

### SUMMARY

In one embodiment, a computer based method of parsing data in a variety of formats to display into a format to assist in insurance decision making is disclosed. The system and method may determine a claim type and may determine needed claim information for the claim type. The system and method may review material submitted for needed claim information and determine missing information from needed claim information. The missing information may be obtained from an additional source, the needed claim information may be completed, and the needed claim information may be displayed in a user interface.

### BRIEF DESCRIPTION OF THE DRAWINGS

FIG. 1 may be an illustration of computer based learning system;

FIG. 2 may be an illustration of a method in accordance with the claims;

FIG. 2a may be an illustration of fields being identified in a document to be scanned into computer useable information;

FIG. 2b may be an illustration of fields being identified in a document to be scanned into computer useable information;

FIG. 2c may illustrate a sample name entity recognition module;

FIG. 2d may illustrate some examples of search being executed against material in an electronic file;

FIG. 2e may be an illustration of a chatbot obtaining more information for an insurance provider;

FIG. 2f may be an illustration of name information being analyzed for validation;

FIG. 2g may be an illustration of data being displayed based on the persona of the user;

FIG. 3 may be an illustration of a convolutional neural network and a transformer neural network to perform claim resolution tasks; and

FIG. 4 may be an illustration of a computer that may be physically transformed to execute the method.

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein. All dimensions specified in this disclosure may be by way of example only and are not intended to be limiting. Further, the proportions shown in these Figures may not be necessarily to scale. As will be understood, the actual dimensions and proportions of any system, any device or part of a system or device disclosed in this disclosure may be determined by its intended use.

### SPECIFICATION

Persons of ordinary skill in the art will appreciate that elements in the figures are illustrated for simplicity and clarity so not all connections and options have been shown to avoid obscuring the inventive aspects. For example, common but well-understood elements that are useful or necessary in a commercially feasible embodiment are not often depicted in order to facilitate a less obstructed view of these various embodiments of the present disclosure. It will be further appreciated that certain actions and/or steps may be described or depicted in a particular order of occurrence while those skilled in the art will understand that such specificity with respect to sequence is not actually required. It will also be understood that the terms and expressions used herein are to be defined with respect to their corresponding respective areas of inquiry and study except where specific meanings have otherwise been set forth herein. All dimensions specified in this disclosure may be by way of example only and are not intended to be limiting. Further, the proportions shown in these Figures may not be necessarily to scale. As will be understood, the actual dimensions and proportions of any system, any device or part of a system or device disclosed in this disclosure may be determined by its intended use.

The system and method attempt to address the technical problem of how to design a computer system to automatically obtain all the necessary information to evaluate a claim from a variety of sources and display it in an easy to read and understand format. The technical solution creates a practical application in the form of a user interface that is a leap forward from present systems and is simply more than a data collection system but requires intelligence, detailed analysis and speed that is beyond human capabilities.

Methods and devices that may implement the embodiments of the various features of the invention will now be described with reference to the drawings. The drawings and the associated descriptions may be provided to illustrate embodiments of the invention and not to limit the scope of the invention. Reference in the specification to “one embodiment” or “an embodiment” may be intended to indicate that a particular feature, structure, or characteristic described in connection with the embodiment may be included in at least an embodiment of the invention. The appearances of the phrase “in one embodiment” or “an embodiment” in various places in the specification may not necessarily be referring to the same embodiment.

Throughout the drawings, reference numbers may be re-used to indicate correspondence between referenced elements. As used in this disclosure, except where the context requires otherwise, the term “comprise” and variations of the term, such as “comprising”, “comprises” and “comprised” may not be intended to exclude other additives, components, integers or steps.

In the following description, specific details may be given to provide a thorough understanding of the embodiments. However, it may be understood by one of ordinary skill in the art that the embodiments may be practiced without these specific details. Well-known circuits, structures and techniques may not be shown in detail in order not to obscure the embodiments. For example, circuits may be shown in block diagrams in order not to obscure the embodiments in unnecessary detail.

Also, it is noted that the embodiments may be described as a process that is depicted as a flowchart, a flow diagram, a structure diagram, or a block diagram. The flowcharts and block diagrams in the figures may illustrate the architecture, functionality, and operation of possible implementations of systems, methods and computer programs according to various embodiments disclosed. In this regard, each block in the flowchart or block diagrams may represent a module, segment, or portion of code, that may include one or more executable instructions for implementing the specified logical function(s). It should also be noted that, in some alternative implementations, the functions noted in the blocks may occur out of the order noted in the figures.

Although a flowchart may describe the operations as a sequential process, many of the operations may be performed in parallel or concurrently. In addition, the order of the operations may be rearranged. A process may be terminated when its operations are completed. A process may correspond to a method, a function, a procedure, a subroutine, a subprogram, etc. When a process corresponds to a function, its termination may correspond to a return of the function to the calling function or the main function. Additionally, each block of the block diagrams and/or flowchart illustration, and combinations of blocks in the block diagrams and/or flowchart illustration, may be implemented by special purpose hardware-based systems that perform the specified functions or acts, or combinations of special purpose hardware and computer instructions.

Moreover, a storage may represent one or more devices for storing data, including read-only memory (ROM), random access memory (RAM), magnetic disk storage mediums, optical storage mediums, flash memory devices and/or other non-transitory machine readable mediums for storing information. The term “machine readable medium” may include but is not limited to portable or fixed storage devices, optical storage devices, wireless channels and various other non-transitory mediums capable of storing, comprising, containing, executing or carrying instruction(s) and/or data.

Furthermore, embodiments may be implemented by hardware, software, firmware, middleware, microcode, or a combination thereof. When implemented in software, firmware, middleware or microcode, the program code or code segments to perform the necessary tasks may be stored in a machine-readable medium such as a storage medium or other storage(s). One or more than one processor may perform the necessary tasks in series, distributed, concurrently or in parallel. A code segment may represent a procedure, a function, a subprogram, a program, a routine, a subroutine, a module, a software package, a class, or a combination of instructions, data structures, or program statements. A code segment may be coupled to another code segment or a hardware circuit by passing and/or receiving information, data, arguments, parameters, or memory contents. Information, arguments, parameters, data, etc. may be passed, forwarded, or transmitted through a suitable means including memory sharing, message passing, token passing, network transmission, etc. and are also referred to as an interface, where the interface is the point of interaction with software, or computer hardware, or with peripheral devices.

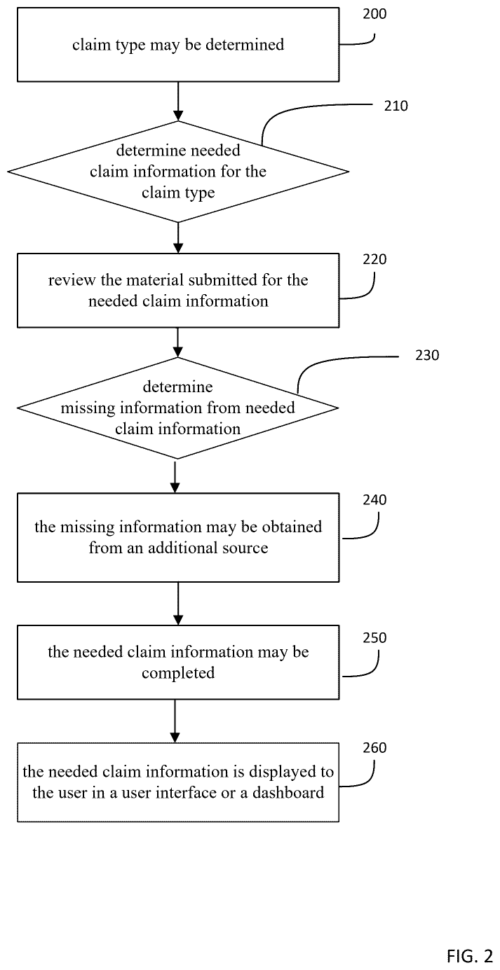

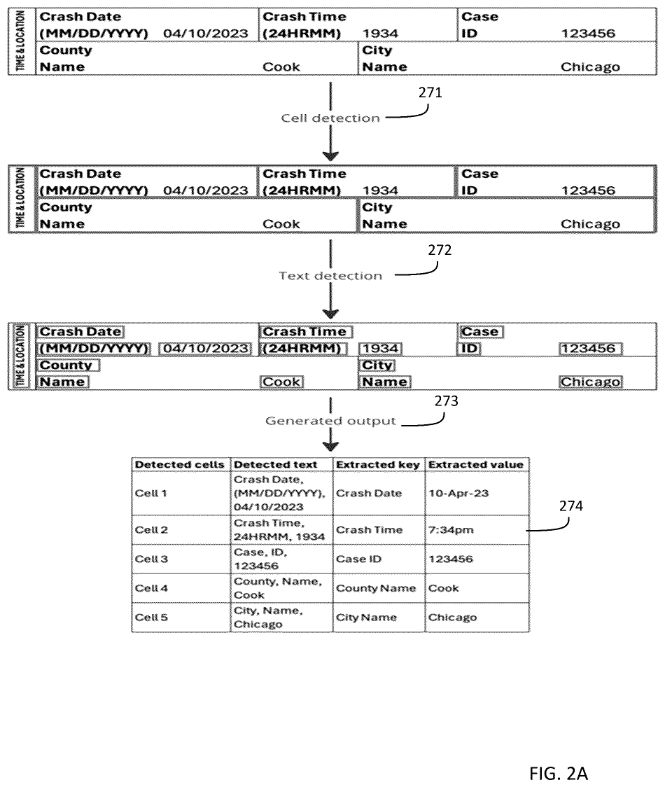

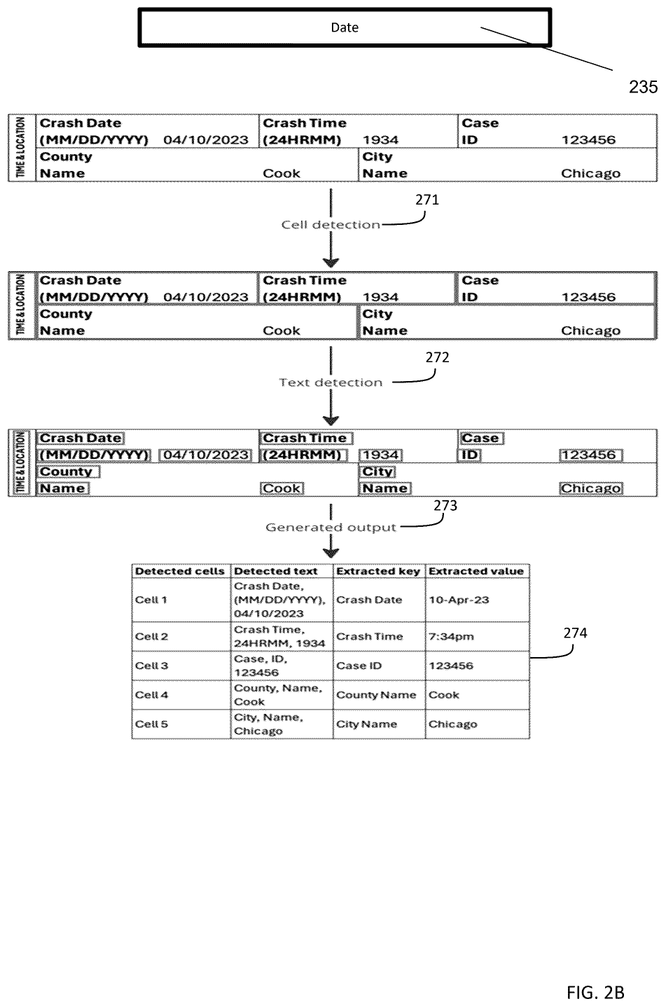

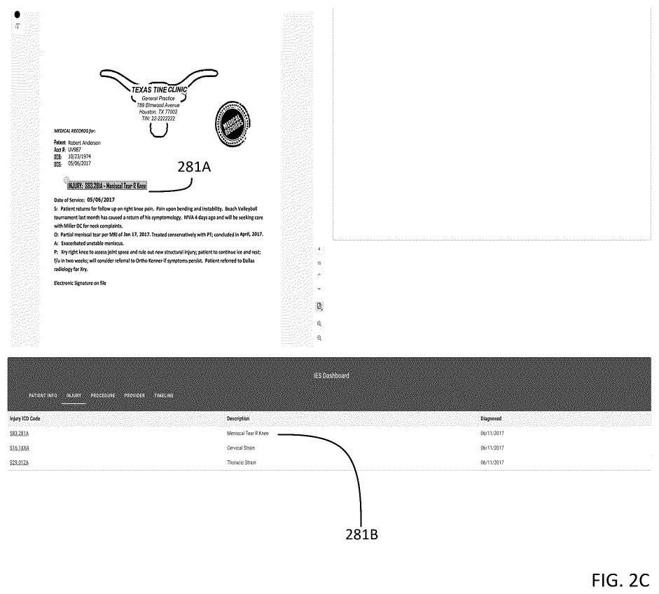

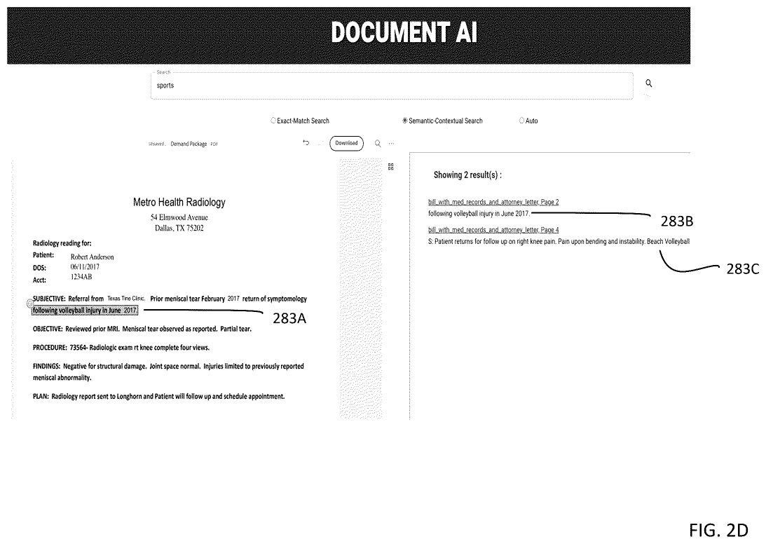

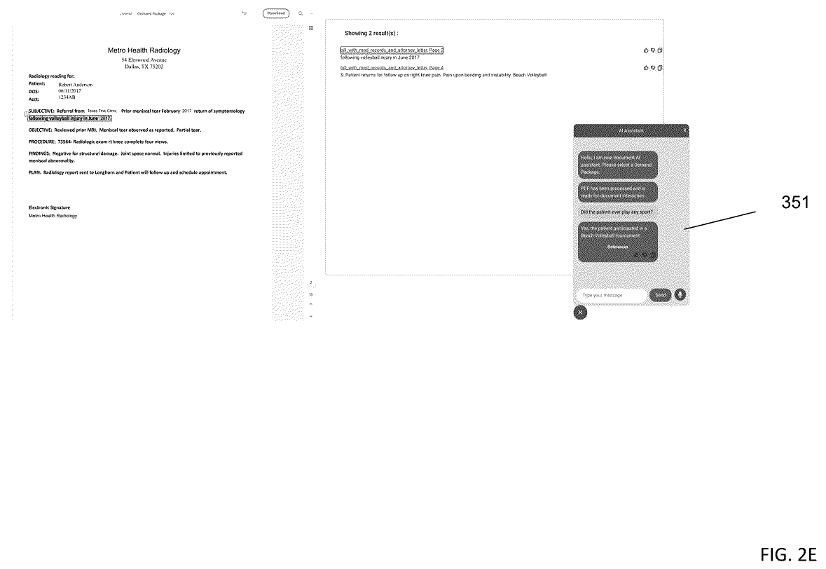

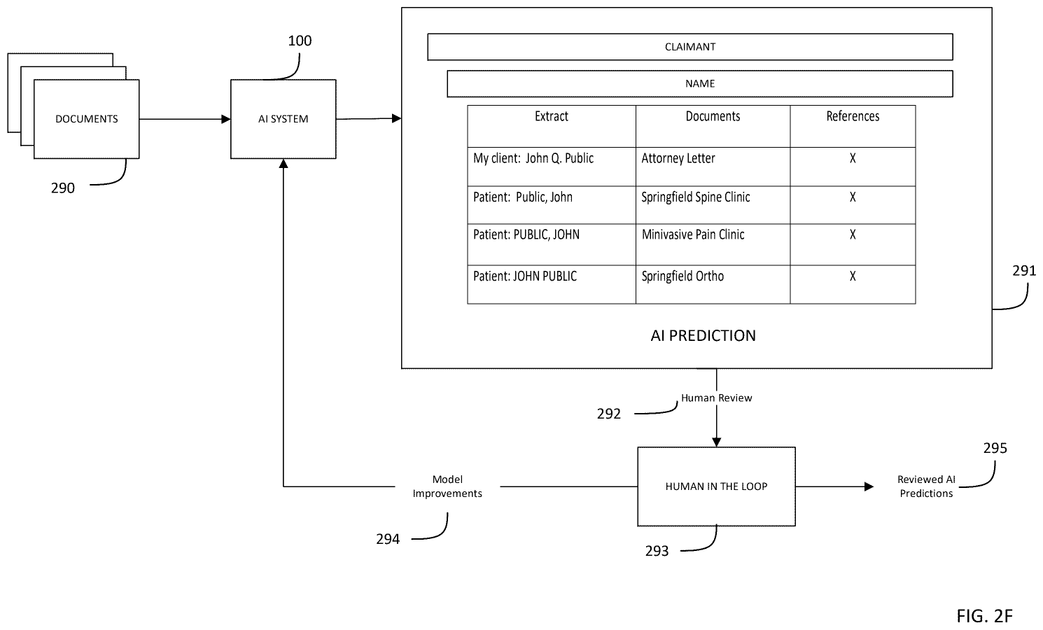

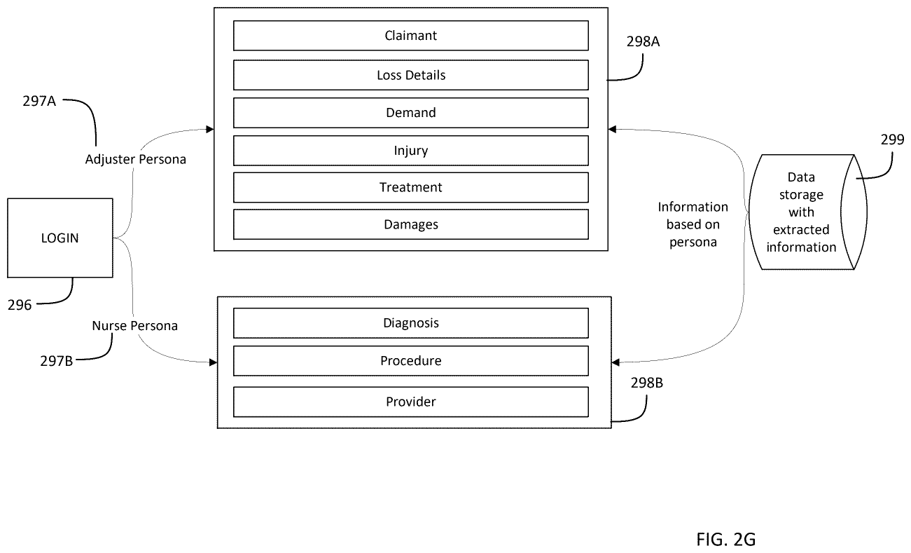

Referring to FIG. 2, a computer based method of parsing data in a variety of formats to display into a format such as an electronic dashboard to assist in insurance decision making may be described. At block 200, a claim type may be determined. For example, a claim may be for damage to a car, damage to a house or medical injuries resulting from a variety of sources. The purpose of determining the type of claim is that different information may be needed for each different claim type. For example, for an injury claim, the human injuries may be needed along with the medical codes of the injuries. In a claim for damage to a physical structure, the age of the dwelling may be necessary, and any estimates of the amount required to fix the damage. Logically, in a medical claim, it does not make sense to search for the age of a structure and in a property claim, it does not make sense to search for medical codes.

At block 210, the system and method may determine needed claim information for the claim type. For the purpose of efficiently gathering claim information, needed information may be required to make a determination on a claim. For example, a medical claim may require medical codes. The system and method may recognize that all injury claims may require medical codes while property claims may not require injury codes. To be efficient, the system and method may only search for the needed claim information.

The information may be thought of in a variety of ways. In some examples, specific data may be needed such as medical codes for an injury. The medical codes may be part of a category of data that may be needed for injury claims. The categories may be displayed on the user interface. There may be a plurality of injuries and related medical codes and the injuries may be listed under the “injury” category heading.

In some embodiments, each type of claim may have a predetermined list of needed data. For the purpose of gathering all the needed data at once and not any unneeded data, in additional embodiments, artificial intelligence or a large language model made be used to study past claims and determine the needed data. As a result, the needed data may be identified with even more granularity and accuracy. For example, a broken arm may not be challenging to determine the needed data but a broken arm that has been repeatedly broken in the past may require additional needed information to better identify risks and remedies along with a claim determination.

In some embodiments, the large language model may be trained used data from the specific insurance company. In other embodiments, the insurance companies may share anonymous data to create a larger pool of data to be used to train the large language model.

At block 220, the system and method may review the material submitted for the needed claim information. For the purpose of filling in the user interface, all the fields in the user interface may require having some information such as the needed information. The system and method may review the electronic file for the needed information. In some instances, all the needed information may be in the electronic file as it exists. In other instances, some needed information may not be present in the electronic file as it exists.

The needed information may contain different types of material. For the purpose of efficiently reviewing the material, it may be useful to know the type of material in advance of spending significant computing resources to analyze all the material. For example, a legal letter may have many paragraphs extolling the skills of the attorney. The skills of an attorney to recover vast amounts may have no relation to the needed information. Thus, if the material is determined to be an attorney letter, the sections about the skills of the attorney in settling cases make not need to be reviewed or analyzed.

For the purpose of efficiently classifying material as document types, the review make take in texts, images and any other metadata to assist in determining the material type. For example, many attorneys have letterhead and the images from the letterhead my indicate the material is an attorney letter. In some additional embodiments, a large language model may be created using past materials and the current materials may be submitted to the large language model for a determination on the document type.

In response to a document type being determined, relevant sections of the material may be scanned or reviewed for needed information and sections of the material that are not relevant may not be scanned. In some embodiments, the non-relevant material may be scanned but the amount of computing power devoted to determining the contents of the non-relevant material may be minimal or reduced. In some additional embodiments, a large language model may be created using past materials and the current materials may be submitted to the large language model for a determination of the relevant sections of the materials.

The material that may be determined to be relevant may be scanned and converted into machine understandable information. For example, information describing the injuries, related medical codes and hospital costs may be relevant and may be classified as damages. Similarly, if the materials are medical records, the relevant injuries, actions taken, future recommendations and costs may be scanned and converted to text that may be understood by the computing device.

### Machine Learning

Machine learning may be used to recognize patterns. The machine learning model may be trained on a model on an existing dataset and using the model to predict whether the claim matches a known pattern of claim resolution. The machine learning model may be used to predict future actions based on past pattern recognition. The machine learning model may also be used to determine pattern deviation. Logically, pattern deviation may be used to determine future actions.

A framework for machine learning algorithm like a large language model may involve a combination of one or more components, sometimes three components: (1) representation, (2) evaluation, and (3) optimization components. Representation components refer to computing units that perform steps to represent knowledge in different ways, including but not limited to as one or more decision trees, sets of rules, instances, graphical models, neural networks, support vector machines, model ensembles, and/or others. Evaluation components refer to computing units that perform steps to represent the way hypotheses (e.g., candidate programs) are evaluated, including but not limited to as accuracy, prediction and recall, squared error, likelihood, posterior probability, cost, margin, entropy k-L divergence, and/or others. Optimization components refer to computing units that perform steps that generate candidate programs in different ways, including but not limited to combinatorial optimization, convex optimization, constrained optimization, and/or others. In some embodiments, other components and/or sub-components of the aforementioned components may be present in the system to further enhance and supplement the aforementioned machine learning functionality.

Machine learning algorithms sometimes rely on unique computing system structures. Machine learning algorithms may leverage neural networks, which are systems that approximate biological neural networks (e.g., the human brain). Such structures, while significantly more complex than conventional computer systems, are beneficial in implementing machine learning. For example, an artificial neural network may be comprised of a large set of nodes which, like neurons in the brain, may be dynamically configured to effectuate learning and decision-making.

Machine learning tasks are sometimes broadly categorized as either unsupervised learning or supervised learning. In unsupervised learning, a machine learning algorithm is left to generate any output (e.g., to label as desired) without feedback. The machine learning algorithm may teach itself (e.g., observe past output), but otherwise operates without (or mostly without) feedback from, for example, a human administrator. Meanwhile, in supervised learning, a machine learning algorithm is provided feedback on its output. Feedback may be provided in a variety of ways, including via active learning, semi-supervised learning, and/or reinforcement learning. In active learning, a machine learning algorithm is allowed to query answers from an administrator. For example, the machine learning algorithm may make a guess in a face detection algorithm, ask an administrator to identify the photo in the picture, and compare the guess and the administrator's response. In semi-supervised learning, a machine learning algorithm is provided a set of example labels along with unlabeled data. For example, the machine learning algorithm may be provided a data set of 100 photos with labeled human faces and 10,000 random, unlabeled photos. In reinforcement learning, a machine learning algorithm is rewarded for correct labels, allowing it to iteratively observe conditions until rewards are consistently earned. For example, for every face correctly identified, the machine learning algorithm may be given a point and/or a score (e.g., “75% correct”). An embodiment involving supervised machine learning is described herein.

As elaborated herein, in practice, machine learning systems and their underlying components are tuned by data scientists to perform numerous steps to perfect machine learning systems. The process is sometimes iterative and may entail looping through a series of steps: (1) understanding the domain, prior knowledge, and goals; (2) data integration, selection, cleaning, and pre-processing; (3) learning models; (4) interpreting results; and/or (5) consolidating and deploying discovered knowledge. This may further include conferring with domain experts to refine the goals and make the goals clearer, given the nearly infinite number of variables that can possible be optimized in the machine learning system. Meanwhile, one or more of data integration, selection, cleaning, and/or pre-processing steps can sometimes be the most time consuming because the old adage, “garbage in, garbage out,” also reigns true in machine learning systems.

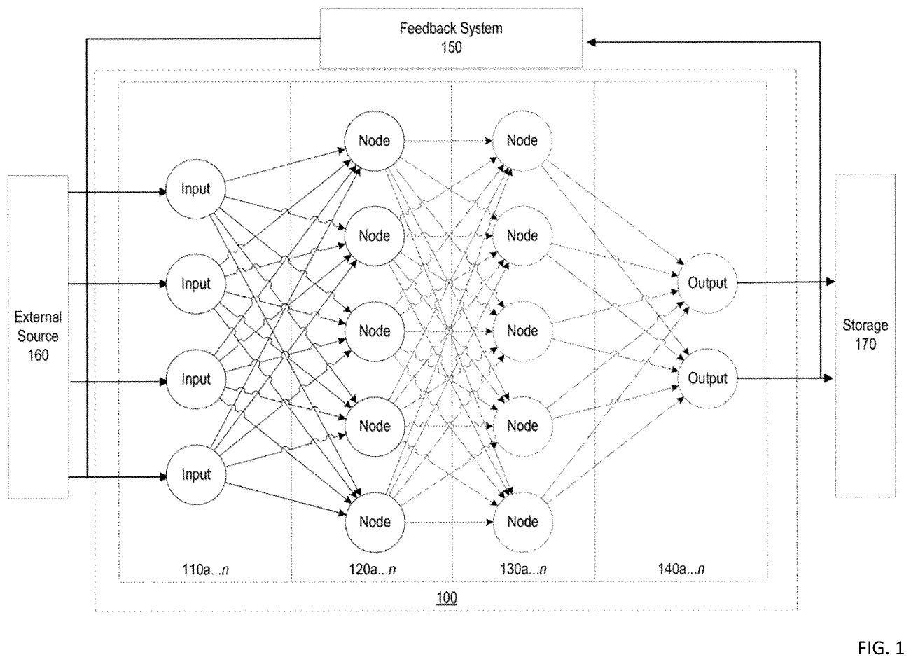

By way of example, FIG. 1 illustrates a simplified example of an artificial neural network 100 on which a machine learning algorithm may be executed. FIG. 1 is merely an example of nonlinear processing using an artificial neural network; other forms of nonlinear processing may be used to implement a machine learning algorithm in accordance with features described herein.

In FIG. 1, each of input nodes 110 a-n is connected to a first set of processing nodes 120 a-n. Each of the first set of processing nodes 120 a-n is connected to each of a second set of processing nodes 130 a-n. Each of the second set of processing nodes 130 a-n is connected to each of output nodes 140 a-n. Though only two sets of processing nodes are shown, any number of processing nodes may be implemented. Similarly, though only four input nodes, five processing nodes, and two output nodes per set are shown in FIG. 1, any number of nodes may be implemented per set. Data flows in FIG. 1 are depicted from left to right: data may be input into an input node, may flow through one or more processing nodes, and may be output by an output node. Input into the input nodes 110 a-n may originate from an external source 160. Output may be sent to a feedback system 150 and/or to storage 170. The feedback system 150 may send output to the input nodes 110 a-n for successive processing iterations with the same or different input data.

In one illustrative method using feedback system 150, the system may use machine learning to determine an output. The output may include anomaly scores, heat scores/values, confidence values, and/or classification output. The system may use any machine learning model including xgboosted decision trees, auto-encoders, perceptron, decision trees, support vector machines, regression, and/or a neural network. The neural network may be any type of neural network including a feed forward network, radial basis network, recurrent neural network, long/short term memory, gated recurrent unit, auto encoder, variational autoencoder, convolutional network, residual network, Kohonen network, and/or other type. In one example, the output data in the machine learning system may be represented as multi-dimensional arrays, an extension of two-dimensional tables (such as matrices) to data with higher dimensionality.

The neural network may include an input layer, a number of intermediate layers, and an output layer. Each layer may have its own weights. The input layer may be configured to receive as input one or more feature vectors described herein. The intermediate layers may be convolutional layers, pooling layers, dense (fully connected) layers, and/or other types. The input layer may pass inputs to the intermediate layers. In one example, each intermediate layer may process the output from the previous layer and then pass output to the next intermediate layer. The output layer may be configured to output a classification or a real value. In one example, the layers in the neural network may use an activation function such as a sigmoid function, a Tan h function, a ReLu function, and/or other functions. Moreover, the neural network may include a loss function. A loss function may, in some examples, measure a number of missed positives; alternatively, it may also measure a number of false positives. The loss function may be used to determine error when comparing an output value and a target value. For example, when training the neural network, the output of the output layer may be used as a prediction and may be compared with a target value of a training instance to determine an error. The error may be used to update weights in each layer of the neural network.

In one example, the neural network may include a technique for updating the weights in one or more of the layers based on the error. The neural network may use gradient descent to update weights. Alternatively, the neural network may use an optimizer to update weights in each layer. For example, the optimizer may use various techniques, or combination of techniques, to update weights in each layer. When appropriate, the neural network may include a mechanism to prevent overfitting-regularization (such as L1 or L2), dropout, and/or other techniques. The neural network may also increase the amount of training data used to prevent overfitting.

Once data for machine learning has been created, an optimization process may be used to transform the machine learning model. The optimization process may include (1) training the data to predict an outcome, (2) defining a loss function that serves as an accurate measure to evaluate the machine learning model's performance, (3) minimizing the loss function, such as through a gradient descent algorithm or other algorithms, and/or (4) optimizing a sampling method, such as using a stochastic gradient descent (SGD) method where instead of feeding an entire dataset to the machine learning algorithm for the computation of each step, a subset of data is sampled sequentially. In one example, optimization comprises minimizing the number of false positives to maximize a user's experience. Alternatively, an optimization function may minimize the number of missed positives to optimize minimization of losses from exploits.

In one example, FIG. 1 depicts nodes that may perform various types of processing, such as discrete computations, computer programs, and/or mathematical functions implemented by a computing device. For example, the input nodes 110 a-n may comprise logical inputs of different data sources, such as one or more data servers. The processing nodes 120 a-n may comprise parallel processes executing on multiple servers in a data center. And the output nodes 140 a-n may be the logical outputs that ultimately are stored in results data stores, such as the same or different data servers as for the input nodes 110 a-n. Notably, the nodes need not be distinct. For example, two nodes in any two sets may perform the exact same processing. The same node may be repeated for the same or different sets.

Each of the nodes may be connected to one or more other nodes. The connections may connect the output of a node to the input of another node. A connection may be correlated with a weighting value. For example, one connection may be weighted as more important or significant than another, thereby influencing the degree of further processing as input traverses across the artificial neural network. Such connections may be modified such that the artificial neural network 100 may learn and/or be dynamically reconfigured. Though nodes are depicted as having connections only to successive nodes in FIG. 1, connections may be formed between any nodes. For example, one processing node may be configured to send output to a previous processing node.

Input received in the input nodes 110 a-n may be processed through processing nodes, such as the first set of processing nodes 120 a-n and the second set of processing nodes 130 a-n. The processing may result in output in output nodes 140 a-n. As depicted by the connections from the first set of processing nodes 120 a-n and the second set of processing nodes 130 a-n, processing may comprise multiple steps or sequences. For example, the first set of processing nodes 120 a-n may be a rough data filter, whereas the second set of processing nodes 130 a-n may be a more detailed data filter.

The artificial neural network 100 may be configured to effectuate decision-making. As a simplified example for the purposes of explanation, the artificial neural network 100 may be configured to detect faces in photographs. The input nodes 110 a-n may be provided with a digital copy of a photograph. The first set of processing nodes 120 a-n may be each configured to perform specific steps to remove non-facial content, such as large contiguous sections of the color red. The second set of processing nodes 130 a-n may be each configured to look for rough approximations of faces, such as facial shapes and skin tones. Multiple subsequent sets may further refine this processing, each looking for further more specific tasks, with each node performing some form of processing which need not necessarily operate in the furtherance of that task. The artificial neural network 100 may then predict the location on the face. The prediction may be correct or incorrect.

The feedback system 150 may be configured to determine whether or not the artificial neural network 100 made a correct decision. Feedback may comprise an indication of a correct answer and/or an indication of an incorrect answer and/or a degree of correctness (e.g., a percentage). For example, in the facial recognition example provided above, the feedback system 150 may be configured to determine if the face was correctly identified and, if so, what percentage of the face was correctly identified. The feedback system 150 may already know a correct answer, such that the feedback system may train the artificial neural network 100 by indicating whether it made a correct decision. The feedback system 150 may comprise human input, such as an administrator telling the artificial neural network 100 whether it made a correct decision. The feedback system may provide feedback (e.g., an indication of whether the previous output was correct or incorrect) to the artificial neural network 100 via input nodes 110 a-n or may transmit such information to one or more nodes. The feedback system 150 may additionally or alternatively be coupled to the storage 170 such that output is stored. The feedback system may not have correct answers at all, but instead base feedback on further processing: for example, the feedback system may comprise a system programmed to identify faces, such that the feedback allows the artificial neural network 100 to compare its results to that of a manually programmed system.

The artificial neural network 100 may be dynamically modified to learn and provide better input. Based on, for example, previous input and output and feedback from the feedback system 150, the artificial neural network 100 may modify itself. For example, processing in nodes may change and/or connections may be weighted differently. Following on the example provided previously, the facial prediction may have been incorrect because the photos provided to the algorithm were tinted in a manner which made all faces look red. As such, the node which excluded sections of photos containing large contiguous sections of the color red could be considered unreliable, and the connections to that node may be weighted significantly less. Additionally, or alternatively, the node may be reconfigured to process photos differently. The modifications may be predictions and/or guesses by the artificial neural network 100, such that the artificial neural network 100 may vary its nodes and connections to test hypotheses.

The artificial neural network 100 need not have a set number of processing nodes or number of sets of processing nodes but may increase or decrease its complexity. For example, the artificial neural network 100 may determine that one or more processing nodes are unnecessary or should be repurposed, and either discard or reconfigure the processing nodes on that basis. As another example, the artificial neural network 100 may determine that further processing of all or part of the input is required and add additional processing nodes and/or sets of processing nodes on that basis.

The feedback provided by the feedback system 150 may be mere reinforcement (e.g., providing an indication that output is correct or incorrect, awarding the machine learning algorithm a number of points, or the like) or may be specific (e.g., providing the correct output). For example, the machine learning algorithm 100 may be asked to detect faces in photographs. Based on an output, the feedback system 150 may indicate a score (e.g., 75% accuracy, an indication that the guess was accurate, or the like) or a specific response (e.g., specifically identifying where the face was located).

The artificial neural network 100 may be supported or replaced by other forms of machine learning. For example, one or more of the nodes of artificial neural network 100 may implement a decision tree, associational rule set, logic programming, regression model, cluster analysis mechanisms, Bayesian network, propositional formulae, generative models, and/or other algorithms or forms of decision-making. The artificial neural network 100 may effectuate deep learning.

A large language model may be a language model characterized by its large size. Their size is enabled by AI accelerators, which are able to process vast amounts of text data, mostly scraped from the Internet. The artificial neural networks which are built can contain from tens of millions and up to billions of weights and are (pre-)trained using self-supervised learning and semi-supervised learning. Transformer architecture contributed to faster training.

As language models, they work by taking an input text and repeatedly predicting the next token or word. Up to 2020, fine tuning was the only way a model could be adapted to be able to accomplish specific tasks. Larger sized models, such as GPT-3, however, can be prompt-engineered to achieve similar results. They are thought to acquire embodied knowledge about syntax, semantics and “ontology” inherent in human language corpora large language models are trained using self-supervised learning or semi-supervised learning. This means that they are trained on large amounts of unlabeled text. Large language models can adjust their internal parameters and learn from new inputs from users over time.

Large language models are trained to predict the next word in a sentence based on the previous input sentence. This is a self-supervised learning task because you are not defining separate output labels. The process is repeated until the model reaches an acceptable level of accuracy. Some large language models, like InstructGPT and ChatGPT, use both supervised learning and reinforcement learning. The combination of the two is crucial for optimal performance.

### Scanning Process

For the purpose of obtaining machine understandable information from the materials, the materials may be scanned. The scanning may take on a variety of forms and follow a variety of processes. At a high level, the system and method may leverage past experience as embodied in a trained large language model to determine relevant sections of documents.

In one embodiment, the system and method may scan every document in the file and convert the text into computer readable information. Images may be analyzed for text. For example, handwritten notes may be converted into computer readable information.

In additional embodiments, relevant sections of the material may be scanned or reviewed for needed information and sections of the material that are not relevant may not be scanned. In some embodiments, the non-relevant material may be scanned but the amount of computing power devoted to determining the contents of the non-relevant material may be minimal or reduced. In some additional embodiments, a large language model may be created using past materials and the current materials may be submitted to the large language model for a determination of the relevant sections of the materials.

The material that may be determined to be relevant may be scanned and converted into machine understandable information. For example, information describing the injuries, related medical codes and hospital costs may be relevant and may be classified as damages. Similarly, if the materials are medical records, the relevant injuries, actions taken, future recommendations and costs may be scanned and converted to text that may be understood by the computing device.

More specifically as illustrated in FIGS. 2a and 2b, a document may be scanned to determine cells that contain data. Visualization of how cells may be detected in forms to improve OCR extraction. One embodiment may use intelligent document processing output (for example, using Textract from AWS or Azure Form Recognizer from Microsoft). In FIG. 2a, the cells may be detected and in FIG. 2b, the extracted text may be related to the correspondent cell. The top left cell 235 with the date may be colored to show it as an example.

The cells may be cropped from the documents and analyzed individually. The data from the cells may be converted into machine understandable information. The machine understandable information may be then analyzed and assigned to categories such as damage amount, previous accidents, locations, etc. In some embodiments, a large language model may be used to analyze the machine understandable information to determine if it is linked to a category. The machine understandable information may be linked to needed claim information.

FIG. 2c may illustrate a sample name entity recognition module. The module may extract useful information for the claim adjusters from the document. One of the mechanisms that may be used is passing the page context to a large language model like GPT-4 and asking the model about the information desired to be extracted. The large language model that may be used may be open source like Mixtral 7x8B. Versions may be fine-tuned versions of open-source large language models or completely trained from scratch with company data.

At block 230, for the purpose of finding missing data that would be useful in the user interface/dashboard, missing information from needed claim information may be determined. In a very simple example, a claim may need information Able data, Baker data and Charlie data. The existing materials in the file may disclose Able data and Baker data meaning that Charlie data is not in the materials. In a more realistic embodiment, a large language model may analyze the machine understandable information to determine if it is needed claim information. The large language model may be trained on data from past claims from the insurance company or from a plurality of insurance companies using anonymous data.

At block 240, for the purpose of finding missing data that would be useful in the user interface/dashboard, the missing information may be obtained from an additional source. As an example, a medical claim code may have a standard recovery value related to it. The code value may be in a separate database and may change over time or based on location or based on the type of hospital. The system and method may query the separate database to obtain the value of the medical code claim.

Of course, the cost of a medical code claim may be a simple example. In other examples, obtaining the missing data may be more complex. For example, say a client is requesting reimbursement for a new roof due to hail damage. An insurance company representative may desire to confirm there was hail in area on the day and time the damage allegedly occurred. The system and method may query relevant weather sources that store data on past weather occurrences to verify hail was in the relevant area of the damage claim at the relevant time. Further, the system and method may query to determine if similar claims have been made for other structures in the area. Obviously, the research may become quite in-depth and from multiple sources and such extensive research may be contemplated.

At block 250, the needed claim information may be completed. For the purpose of displaying all the necessary information to a user, the system may search for the relevant data to complete a dashboard view which may contain all the necessary information. The system and method may take steps to locate the information needed to complete the dashboard until all the necessary data has been collected. If the necessary data cannot be obtained, a message may be displayed to the user that indicates that the needed data could not be obtained. In some embodiments, a hyperlink may be provided that links to a display of the steps taken to obtain the needed data.

In some embodiments, the needed claim information may be validated. The purpose of validating the information may be to provide confidence to users that the data may be complete and may be trustworthy. As an example, a single name may have a surprising number of formats. For example, the following name variations for a patient may refer to the same person:
John Q. Public;
John Public;
J. Q. Public;
J. Public;
Public, John Q.;
Public, John;
Public, J. Q.; and
Public, J.

The data may be verified in a variety of ways. In the John Q. Public patient example, additional data may be stored with each name variation and the additional data may be used to verify that each of the John Q. Public name variations refer to the same patient. Additional data may be any data that would be expected to be in a medical file such as a date of birth, height, eight, an identification code, past claims or an address. If the additional data match is over a threshold, the various name variations may be connected in order to capture all the data on a specific patient.

In operation, a first doctor may have a file on John Q. Public and a physical therapist may have a file on J. Public. By comparing the height, weight or birthday of John Q. Public and J. Public, the system may be able to determine if both names relate to the same person. If there is a match between the height, weight or birthday of John Q. Public and J. Public, the files may be combined. By combining the files, the users may be confident they are viewing all the relevant data on an individual. Further, the system may allow users to select the various pieces of data used as matching to view the source data (i.e., files at the first doctor or the files from the physical therapist) to verify the data on their own.

The matching of files to the same individual may occur in a variety of ways. In some examples, a variety of data types are compared, the comparisons are score based on the similarity, and the scores may be totaled.

In some embodiments, the proof of the data validation may be viewed by selecting a hyperlink to the source of the data. For example, by selecting “J. Public”, the backup data that was used to verify J. Public is the same as John Q. Public, such as both data files have the same identification number or the same address, may be displayed. In some instances, the data used to match the various John Q. Public variations may be highlighted.

FIG. 2f may illustration how the pieces of the system operate to create the validated data. Multiple documents may be scanned by the system and communicated to the AI System 100. The AI system may analyze the various fields of extracted data and determine whether any of the names refer to the same person. The names may be displayed to a user in a user interface 291 where the names may be selected to determine the source of the name. At block 292, in some instances the data may be reviewed by a human 292, 293. The AI predictions of whether the various names may be reviewed and communicated to the user 295 and may be communicated back to the AI model 100 to improve predictions in the future 294.

At block 260, the needed claim information may be displayed to the user in a user interface or a dashboard. As described previously, the dashboard may contain all the needed data to dispose of a claim based on the claim type. The needed claim information may include links to the underlying source documents. For example, if a client is requesting coverage for a new roof, the user interface may include a link to the estimates to replace the roof including the type of shingles, the labor cost, etc.

In some embodiments, the data may be configured according to the user or the user persona/user role. As different users desire to see different data, it may be useful to display the specific data desired by the user. For example, a medical auditor may only desire to see data related to medical issues. In some embodiment, the configuration may be specific to a role such as a medical auditor or auto damage representative and in other embodiments, the system and method may be adapted to allow users to configure that data to each person.

The configuration may be accomplished in a variety of ways. In some embodiments, the user may have an option to set up the configuration of the data when using the system. In other embodiments, an authority may set up the configuration for each individual or for each classification of individuals. For example, medical auditors may be classified together but the specific organizations or individuals may be able to tailor the display of data that they desire to see. A database or other appropriate file structure may be used to store the desired display configuration for the users and the display may be created automatically when the specific user may be recognized.

FIG. 2g may illustrate the data configuration flow. At block 296, a user may log in. Assuming the login is recognized, the system may determine the appropriate persona for the user where the persona may represent a role or may represent individual preferences of a user. The user may then be showing a display the contains different information based on the persona. For example, the adjustor persona 297A may see the claimant 298A data from the data storage 299 that is relevant to the adjuster persona 297A. Similarly, the nurse persona 297B may see the claimant data 298B from the data storage 299 that is relevant to the nurse persona 297B.

As a result of the system and method, all the necessary information to make a decision on a claim of a specific type may be present in a dashboard. In operation, an insurance representative may review the dashboard and may have all the necessary information to make a decision on a claim whereas in the past, an insurance representative may have had to flip through paper files or make repeated queries into separate databases on different networks to obtain the necessary information.

In an additional embodiment, the system may analyze the information in the dashboard and make a recommendation on the claim. In some embodiments, the recommendation may be an amount to pay on the claim. In other situation, the recommendation may be to deny the claim. The recommendation may be made using machine learning or a large language model that may analyze past claims and facts pattern and the eventual resolutions of the claims. In some embodiments, the recommendation may be a reviewed by an insurance representative before a final decision is made on the claim where in other embodiments, the recommendation may be the final decision on the claim.

Additional factors may be used to determine if the recommendation needs to be reviewed by an insurance representative or if the recommendation may be a final decision. For example, if the claim is for a small amount and the variance of previous claim resolutions is narrow, a recommendation may be final. In other embodiments, if the confidence of the machine language model or machine learning is low, then the need for review by an insurance representative may be higher.

The system and method may gather the data, make the necessary determinations and gather the needed information automatically. The system and method may present the data to the insurance representative in virtually real time. The representative may only have to select to review a claim and the system and method may proceed through the steps automatically and fill in the dashboard.

In some embodiments, the insurance representative may be able to customize the dashboard and the customization may be specific to the type of claim. By allowing customization, the system and method may allow the insurance representative to be even more efficient by presenting the dashboard in a form the representative may desire. For example, a representative may be an expert on hail-based roof claims, data related to roofing may be moved to a more prominent position while information related to landscape damage from the hail may be moved to a less prominent position.

If the insurance representative has a question about the information in the dashboard, the representative may select the data in one of the fields and see the backup data for the information. In an additional aspect, a chatbot 255 may be present as illustrated in FIG. 2e. The chatbot 255 may take in questions or queries and may retrieve answers to questions from the user or from the system. The chatbot 255 may use a traditional keyword match-based search or may use a vector database for search. FIG. 2d may illustrate some examples of search being executed against material in an electronic file.

In some embodiments, a determination may be made to highlight certain data in the dashboard. For example, if the machine learning and or large language model find that data in just one field to be out of the expected norm, it may be highlighted. For example, if an amount to fix a car is higher than the purchase price of the car, the amount may be highlighted. Of course, if the car is rare and has increased in value, it may make sense that the amount to fix the car is higher than the purchase price and this data may be displayed if the highlighted field is selected.

In the process of creating a claim resolution determination, some data may be given more importance or weights than other data. Logically, the weights may be created using a learning algorithm such as an artificial intelligence model which may study a significant amount of relevant data over time to better adjust the weights.

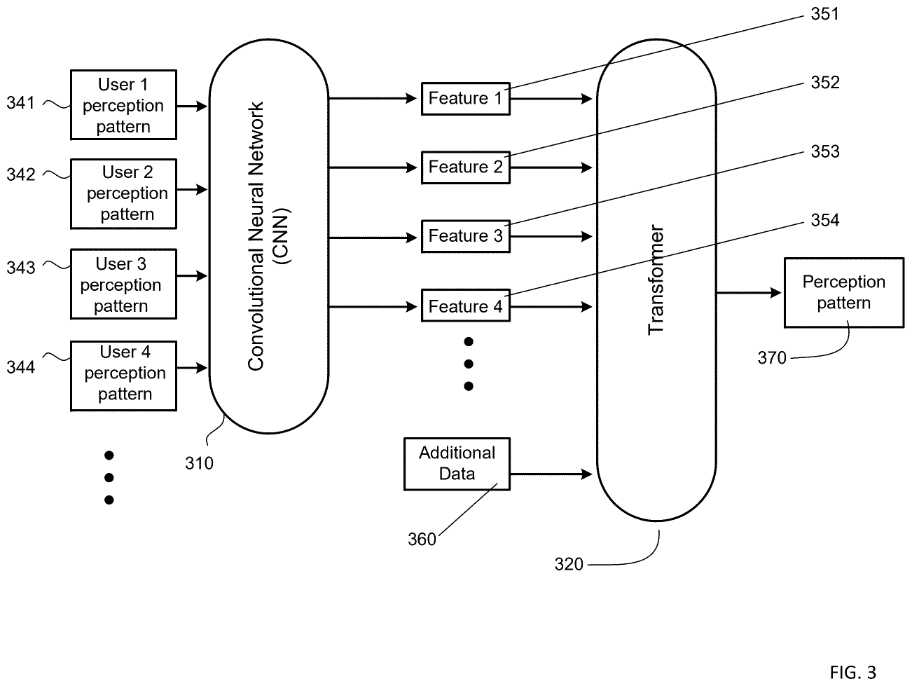

Many learning algorithms may be used. In one embodiment, referring to FIG. 3, the learning algorithm may include a convolutional neural network 510 (CNN) and a transformer 320. In one embodiment, the CNN 310 may determine one or more features 351-354 for each user 341-344. In one example, the CNN may determine the features 351-354 which may be a set of numbers but the number of features 351-354 may be varied up or down depending on many factors.

The CNN may be trained on millions of past claims and may have learned to understand the value of claims. This CNN may be novel because it has been created and trained on claim data that may be proprietary to the insurance company. Logically, other types of learning algorithms in the method and system may be used. For example, the learning algorithm may be a fully connected neural network (FCN) in one embodiment.

In training, the transformer 320 may take the features 351-354 of multiple claims 341-344 of a similar type (the outputs of the CNN) as well as additional data such any additional information provided by the insured 360 to create a model. Once the model is trained, the transformer may generate predictions of the claim resolutions 370. In some embodiments, the claim resolution 370 may be in real time. The transformer 320 used in this invention may be trained on a dataset specifically created for claim resolutions 370.

The trained model which may be in the transformer 320 may take the features of users-344 as well as outside information in order to predict the claim resolutions. The learning algorithm also may analyze other relevant information about the claim.

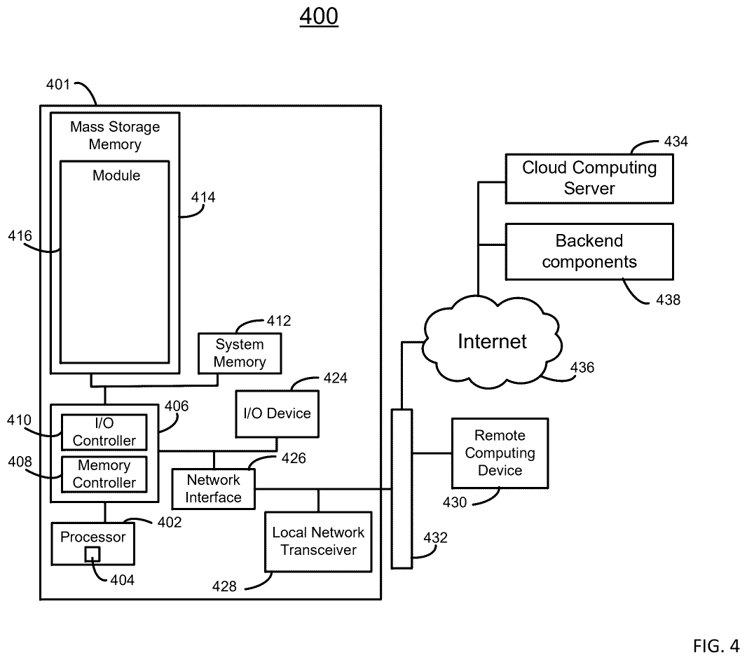

Computing devices are used through the method and system. As shown in FIG. 4, the computing device 401 that executes the method may include a processor 402 that is coupled to an interconnection bus. The processor 402 may include a register set or register space 404, which is depicted in FIG. 4 as being entirely on-chip, but which could alternatively be located entirely or partially off-chip and directly coupled to the processor 402 via dedicated electrical connections and/or via the interconnection bus. The processor 402 may be any suitable processor, processing unit or microprocessor. Although not shown in FIG. 4, the computing device 401 may be a multi-processor device and, thus, may include one or more additional processors that are identical or similar to the processor 402 and that are communicatively coupled to the interconnection bus.

The processor 402 of FIG. 4 may be coupled to a chipset 406, which includes a memory controller 408 and a peripheral input/output (I/O) controller 410. As is well known, a chipset may typically provide I/O and memory management functions as well as a plurality of general purpose and/or special purpose registers, timers, etc. that are accessible or used by one or more processors coupled to the chipset 406. The memory controller 408 may perform functions that enable the processor 402 (or processors if there are multiple processors) to access a system memory 412 and a mass storage memory 414, that may include either or both of an in-memory cache (e.g., a cache within the memory 412) or an on-disk cache (e.g., a cache within the mass storage memory 414).

The system memory 412 may include any desired type of volatile and/or non-volatile memory such as, for example, static random access memory (SRAM), dynamic random access memory (DRAM), flash memory, read-only memory (ROM), etc. The mass storage memory 414 may include any desired type of mass storage device. For example, the computing device 401 may be used to implement a module 416 (e.g., the various modules as herein described). The mass storage memory 414 may include a hard disk drive, an optical drive, a tape storage device, a solid-state memory (e.g., a flash memory, a RAM memory, etc.), a magnetic memory (e.g., a hard drive), or any other memory suitable for mass storage. As used herein, the terms module, block, function, operation, procedure, routine, step, and method refer to tangible computer program logic or tangible computer executable instructions that provide the specified functionality to the computing device 401, the systems and methods described herein. Thus, a module, block, function, operation, procedure, routine, step, and method can be implemented in hardware, firmware, and/or software.

In one embodiment, program modules and routines may be stored in mass storage memory 414, loaded into system memory 412, and executed by a processor 402 or may be provided from computer program products that are stored in tangible computer-readable storage mediums (e.g., RAM, hard disk, optical/magnetic media, etc.).

The peripheral I/O controller 410 may perform functions that enable the processor 402 to communicate with a peripheral input/output (I/O) device 424, a network interface 426, a local network transceiver 428, (via the network interface 426) via a peripheral I/O bus. The I/O device 424 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc. The I/O device 424 may be used with the module 416, etc., to receive data from the transceiver 428, send the data to the components of the system 100, and perform any operations related to the methods as described herein. The local network transceiver 428 may include support for a Wi-Fi network, Bluetooth, Infrared, cellular, or other wireless data transmission protocols. In other embodiments, one element may simultaneously support each of the various wireless protocols employed by the computing device 401. For example, a software-defined radio may be able to support multiple protocols via downloadable instructions. In operation, the computing device 401 may be able to periodically poll for visible wireless network transmitters (both cellular and local network) on a periodic basis. Such polling may be possible even while normal wireless traffic is being supported on the computing device 401. The network interface 426 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 408 and the I/O controller 410 are depicted in FIG. 4 as separate functional blocks within the chipset 406, the functions performed by these blocks may be integrated within a single integrated circuit or may be implemented using two or more separate integrated circuits. The computing environment 400 may also implement the module 416 on a remote computing device 430. The remote computing device 430 may communicate with the computing device 401 over an Ethernet link 432. In some embodiments, the module 416 may be retrieved by the computing device 401 from a cloud computing server 434 via the Internet 436. When using the cloud computing server 434, the retrieved module 416 may be programmatically linked with the computing device 401. The module 416 may be a collection of various software playgrounds including artificial intelligence software and document creation software or may also be a Java® applet executing within a Java® Virtual Machine (JVM) environment resident in the computing device 401 or the remote computing device 430. The module 416 may also be a “plug-in” adapted to execute in a web-browser located on the computing devices 401 and 430. In some embodiments, the module 416 may communicate with back end components 438 via the Internet 436.

The system 400 may include but is not limited to any combination of a LAN, a MAN, a WAN, a mobile, a wired or wireless network, a private network, or a virtual private network. Moreover, while only one remote computing device 430 is illustrated in FIG. 6 to simplify and clarify the description, it is understood that any number of client computers may be supported and may be in communication within the system 400.

Additionally, certain embodiments may be described herein as including logic or a number of components, modules, blocks, or mechanisms. Modules and method blocks may constitute either software modules (e.g., code or instructions embodied on a machine-readable medium or in a transmission signal, wherein the code is executed by a processor) or hardware modules. A hardware module may be a tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a processor or other programmable processor) that is temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” may be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” may refer to a hardware module. Considering embodiments in which hardware modules are temporarily configured (e.g., programmed), each of the hardware modules need not be configured or instantiated at any one instance in time. For example, where the hardware modules include a processor configured using software, the processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

The methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs).)

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification may be presented in terms of algorithms or symbolic representations of operations on data stored as bits or binary digital signals within a machine memory (e.g., a computer memory). These algorithms or symbolic representations may be examples of techniques used by those of ordinary skill in the data processing arts to convey the substance of their work to others skilled in the art. As used herein, an “algorithm” may be a self-consistent sequence of operations or similar processing leading to a desired result. In this context, algorithms and operations may involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, may be merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “embodiments,” “some embodiments” or “an embodiment” or “teaching” may mean that a particular element, feature, structure, or characteristic described in connection with the embodiment is included in at least one embodiment. The appearances of the phrase “in some embodiments” or “teachings” in various places in the specification may not necessarily all be referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments may not be limited in this context.

Further, the figures depict preferred embodiments for purposes of illustration only. One skilled in the art may be readily recognize from the following discussion that alternative embodiments of the structures and methods illustrated herein may be employed without departing from the principles described herein.

Upon reading this disclosure, those of skill in the art may appreciate still additional alternative structural and functional designs for the systems and methods described herein through the disclosed principles herein. Thus, while particular embodiments and applications have been illustrated and described, it is to be understood that the disclosed embodiments may not be limited to the precise construction and components disclosed herein. Various modifications, changes and variations, which may be apparent to those skilled in the art, may be made in the arrangement, operation and details of the systems and methods disclosed herein without departing from the spirit and scope defined in any appended claims.

1. A computer based method of parsing data in a variety of formats to display into a format to assist in insurance decision making comprising:
determining a claim type;
determining needed claim information for the claim type;
reviewing material submitted for needed claim information;
determining missing information from needed claim information
obtaining the missing information from an additional source;
completing the needed claim information; and
displaying the needed claim information in a user interface.

2. The method of claim 1, wherein needed claim information comprises a plurality of categories.

3. The method of claim 1, wherein the needed claim information comprises links to the underlying source documents.

4. The method of claim 1, wherein the needed claim information is specific for each claim type.

5. The method of claim 1, wherein the needed claim information is obtained from a large language model.

6. The method of claim 5, wherein the large language model is trained used data from the insurance company.

7. The method of claim 6, wherein the material submitted is analyzed and the material is classified as a type of material.

8. The method of claim 7, wherein the analysis reviews the text and images in the material to classify the materials as a type of material.

9. The method of claim 8, wherein relevant sections for the type of materials are determined and the relevant material is scanned and converted into machine understandable information.

10. The method of claim 9, wherein the data is validated by comparing the data from multiple sources and allowing the sources to be reviewed.

11. The method of claim 9, wherein a document is scanned to determine cells that contain data.

12. The method of claim 11, wherein cells are cropped from the documents and analyzed individually.

13. The method of claim 12, wherein the data from the cells is converted into machine understandable information.

14. The method of claim 13, wherein the machine understandable information is linked to categories.

15. The method of claim 11, wherein a large language model analyzes the machine understandable information to determine if it is linked to a category.

16. The method of claim 15, wherein the machine understandable information is linked to needed claim information.

17. The method of claim 15, wherein a large language model analyzes the machine understandable information to determine if it is needed claim information.

18. The method of claim 1, wherein a chatbot retrieves answers to questions from the user or from the system.

19. The method of claim 1, wherein search uses a vector database for search.

20. A computer system comprising a processor, a memory and an input-output circuit, the processor being physically configured according to computer executable instructions for parsing data in a variety of formats to display into a format to assist in insurance decision making, the computer executable instruction comprising instructions for:
determining a claim type;
determining needed claim information for the claim type;
reviewing material submitted for needed claim information;
determining missing information from needed claim information
obtaining the missing information from an additional source;
completing the needed claim information; and
displaying the needed claim information in a user interface.
